(19) United States
(12) Patent Application Publication
(10) Pub. No.: US 2003/0192294 A1
(43) Pub. Date: Oct. 16, 2003

(54) Filter medium

(76) Inventor: Alan Smithies, Overland Park, KS (US)

Correspondence Address: Blackwell Sanders Peper Martin LLP, Suite 1200, 40 Corporate Woods, 9401 Indian Creek Parkway, Overland Park, KS, 66210, US

(21) Appl. No.: 10/123,641

(22) Filed: Apr. 16, 2002

(51) Int. Cl. B01D 46/00

(52) U.S. Cl. 55/521; 55/524; 55/527; 55/528

(57) ABSTRACT

A filter medium includes at least one first fiber made from a first polymer selected for the chemical and high temperature stability properties needed for a particular operation and at least one second fiber made from a second polymer having a relatively higher glass transition temperature than the first polymer. The filter medium has a higher glass transition temperature than the first fiber, allowing the filtering media to withstand the temperature requirements of the operation, while retaining the chemical resistance of the first fiber. This is particularly useful for pleated filters that are highly temperature dependent, and in industrial baghouse operations where temperatures often exceed the operating range of the first polymers. A method for making the filter medium is also disclosed.

### FIELD OF THE INVENTION

The present invention relates to a filter medium and more specifically to a filter medium adapted for use in a pleated filter cartridge for industrial baghouse operations under adverse environmental conditions including relatively high temperature, relatively high moisture and chemical exposure.

### BACKGROUND OF THE INVENTION

A technique for controlling pollutants and emissions from industrial plants is to remove undesirable particulate matter carried in a gas stream by fabric filtration. Such fabric filtration is accomplished in a particulate matter or dust collection apparatus known in the industry as a “baghouse”. The baghouse typically includes two large chambers, or plenums, that are divided by a tube sheet having a plurality of openings for receiving air filter cartridges, the air cartridges providing fluid communication between the two plenums.

Traditional round filter bags are made from woven or needlepunch media, with smaller, higher surface area pleated filters or cartridges made from spunbond or other non-woven media. These technologies are typically designed for operations under 300° F. (149° C.). Known media typically consist mainly of polyester or polypropylene nonwoven material, which is produced primarily by a spunbond technology, also known as melt spun process, that processes thermoplastic resins into fibers and fabrics in a single process. Generally these products are calandered by applying heat and pressure at the final stages of manufacture to render them relatively stiff compared to traditional needlefelt filter media. Polyester filter medium is usually heat stabilized at temperatures up to 400° F. (204° C.). Previously, the maximum temperature found in the intended operation is about 275-300° F. (135-149° C.). Since the operation temperature is well below the temperature the media will be exposed to in processing, the media is rendered thermally stable in terms of its construction. Also, a major advantage is polyester and polypropylene spunbonded products are thermoplastic polymers, allowing them to be easily pleated, formed or molded by a subsequent operation of heat and pressure. Secondary stiffening resin or resins impregnated into the media to support the pleats are not needed at this relatively low operating temperature.

There are additional limitations associated with the use of filter media, especially in a cartridge having pleated filter media, in relatively high temperature environments or chemically challenging environments. (For purposes of this disclosure, higher or high temperature is meant to include but is not limited to filter media operating above about 300° F. (149° C.).) Complications arise when the pleated filtering media are being processed and manufactured at temperatures similar to the operating temperatures used in the baghouse during filtering. The increased operating temperature causes the media to soften, allowing a level of pleat collapse or pleat pinch to occur. Pleat collapse can restrict air flow and cause increased pressure drop minimizing the advantages of the higher filter surface area of the pleats. Pleat stability is a major factor in the effective life of the filter. For this reason, the use of polymer filter media for use at higher temperatures has been limited.

Conventional polymer filtering fibers for use in pleated media, including polyphenylene sulfide (PPS) based filtering material, are treated with stiffening agent resin systems applied in a secondary process, as is known in the art. The stiffening resin impregnates the fiber medium to stabilize and strengthen the filter, as well as aiding in pleating and pleat retention. These known stiffening resins include bisphenol based epoxies, acrylic based resins, melamine and phenol formaldehyde resins. These resins, commonly used in textile applications, are recommended for use with textile products exposed to high temperatures.

While these stiffening agents are effective to stabilize and strengthen polymer substrates, they cannot completely overcome the softening of the polymer fiber substrate at higher temperatures. Further, the low Tg's (glass transition temperature) of the polymer substrate media often interferes with the curing of the stiffening agent. The stiffening agents are not fully cross-linked or cured when initially dried onto the fiber substrate. Beneficially, this allows the media to re-soften during the pleating process and conform to the pleating action. After subsequent cooling the resin helps maintain the pleat structure. Unfortunately, upon exposure to elevated temperatures during filtering operations the pleated media softens, and the resin does not filly cure and re-stiffen for up to several hours of operating time. This increases the chances for pleat collapse or pleat pinch off which can occur while the material is soft prior to curing.

Two major considerations are made when choosing a polymer substrate. The first is chemical stability for the environment it will be applied in. The more chemically resistant the polymer substrate is to the conditions of the filtering operation the longer the effective filter life. In a chemically corrosive environment such as a coal fired boiler, for example, PPS is preferred because of its high level of resistance to such environments. In cement and kaolin processes, where conditions are favorable for hydrolysis of the substrate polymer, a hydrolysis resistant polymer such as homopolymer acrylic is preferred.

Second, the substrate polymer must be selected for the temperature it is intended to operate in. If the operation temperature is too high relative to the Tg of the polymer fiber used in the substrate, softening, as discussed above, becomes a problem. Complications in selecting a polymer for the substrate arise when the ideal polymer as far as chemical resistance is not optimum for the temperature it will be exposed to.

It is therefore desirable to provide a filter medium capable of withstanding an operating temperature while remaining chemically and thermally stable during relatively high temperature industrial baghouse uses, and to provide a pleated filter utilizing the improved filter medium.

### SUMMARY OF THE INVENTION

A first aspect of the invention is a filter medium having a filter structure and adapted for use in a filter cartridge operating at a filtering temperature. The filter medium comprises at least one first fiber made from a first polymer having a first glass transition temperature and being selected to be chemically stable during the filtering operation, said first fiber present in an amount effective to render the blended polymer chemically stable during a filtering operation. The filter medium further comprises at least one second fiber made from a second polymer having a second glass transition temperature higher than the first glass transition temperature, said second fiber present in an amount effective to render the blended polymer stiff enough to retain the filter structure at the filtering temperature.

In a preferred embodiment, the first fiber includes a polyphenylene sulfide and the second fiber includes a polymer selected from the group comprising an aramid, polyimide, and mixtures thereof. In another preferred embodiment, the first fiber includes a homopolymer acrylic and the second fiber polymer selected is from a group comprising a pre-oxidized acrylic, aramid, glass, polyimide, and mixtures thereof. It is also preferred that a polymer stiffening agent is applied to the filter medium. The first fiber comprises approximately 65% to 90% by weight of the filter medium and is selected to be chemically stable during a filtering operation. The second fiber comprises about 10% to 35% by weight of the filter medium and is selected to render the filter media stiff enough to retain the filter structure at the filtering temperature.

Another aspect of the present invention is a method of making a filter medium comprising the steps of: providing a filter medium of the present invention, calandering the filter medium, providing a stiffening agent, treating the filter medium with the stiffening agent, and curing the treated filter medium.

In a preferred embodiment, the stiffening agent is selected from the group comprising polyimides, epoxies, acrylics, melamines, and phenol formaldehydes, and the method further includes pleating the treated filter medium. Preferably, the substrate is treated with the stiffening agent prior to countering the filter medium.

These and other aspects of the present invention will become apparent to those skilled in the art in light of the following disclosure.

### BRIEF DESCRIPTION OF THE DRAWINGS

FIG. 1 is a schematic view, partly in section, of a baghouse shown with filter cartridges containing the improved pleated filter medium of the present invention installed.

FIG. 2 is an elevational exploded sectional view of the filter cartridge illustrated in FIG. 1.

FIG. 3 is an exploded sectional view of the filter cartridge of FIG. 2.

FIG. 4 is a cross-sectional view of the filter cartridge of FIG. 3 taken along line 4-4 of FIG. 3.

### DETAILED DESCRIPTION

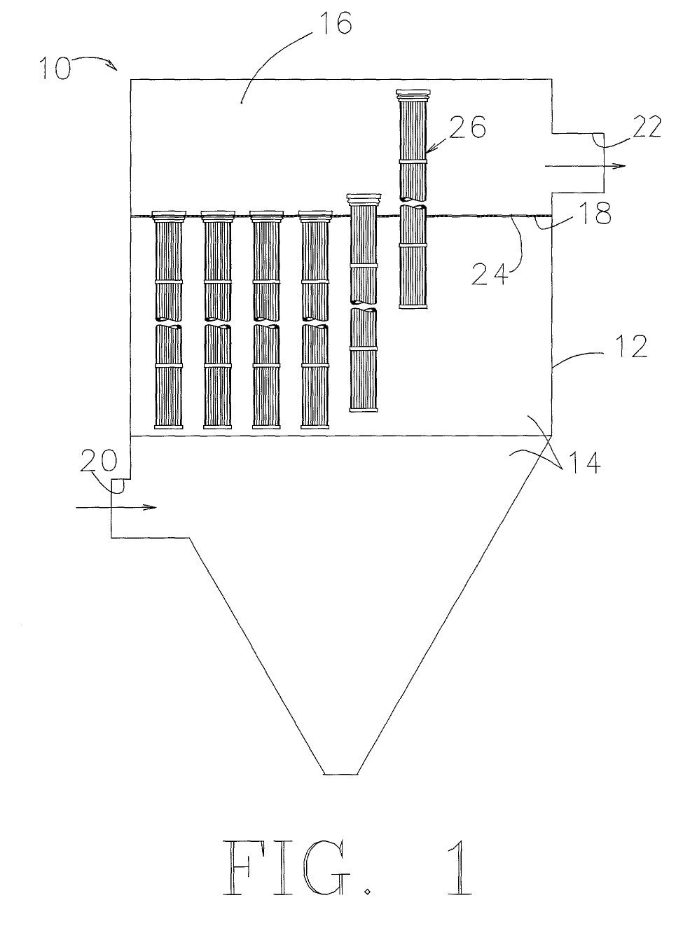

An improved baghouse for using cartridges incorporating pleated filter media of the present invention is shown in FIG. 1, and is further disclosed in U.S. Pat. No. 6,203,591 B1 to J. T. Clements et al., incorporated herein by reference. This baghouse is for purposes of illustration only, and is not meant to limit the use of the present invention to this particular baghouse. The baghouse, generally designated 10, is defined by an enclosed housing 12 that is divided into a “dirty air” plenum 14 and a “clean air” plenum 16 by a tubesheet 18. A dirty air inlet 20 is in fluid communication with the dirty air plenum 14 and a clean air outlet 22 is in fluid communication with clean air plenum 16. The tubesheet 18 includes a plurality of openings 24 sized to accept and retain a plurality of filter cartridges generally designated 26, as shown.

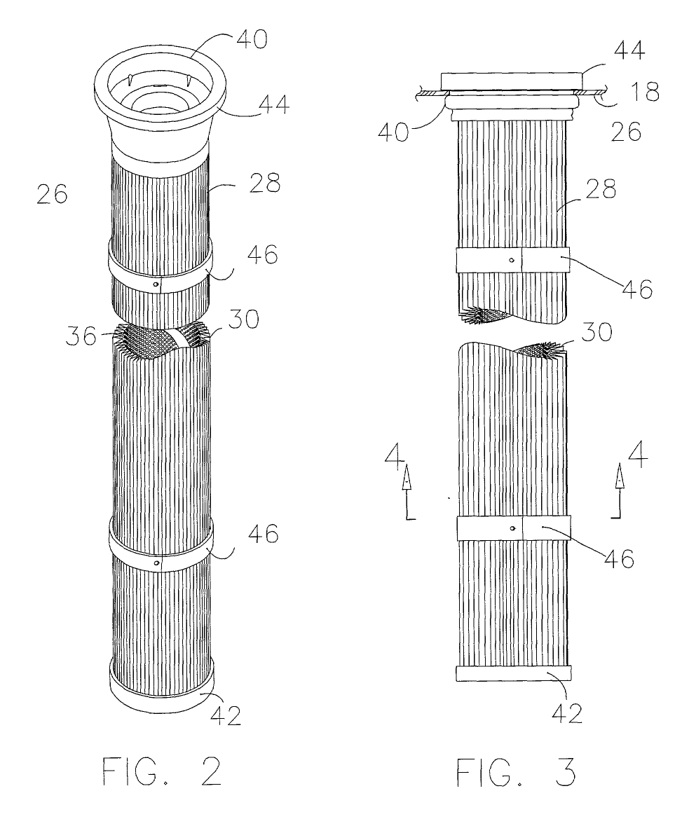

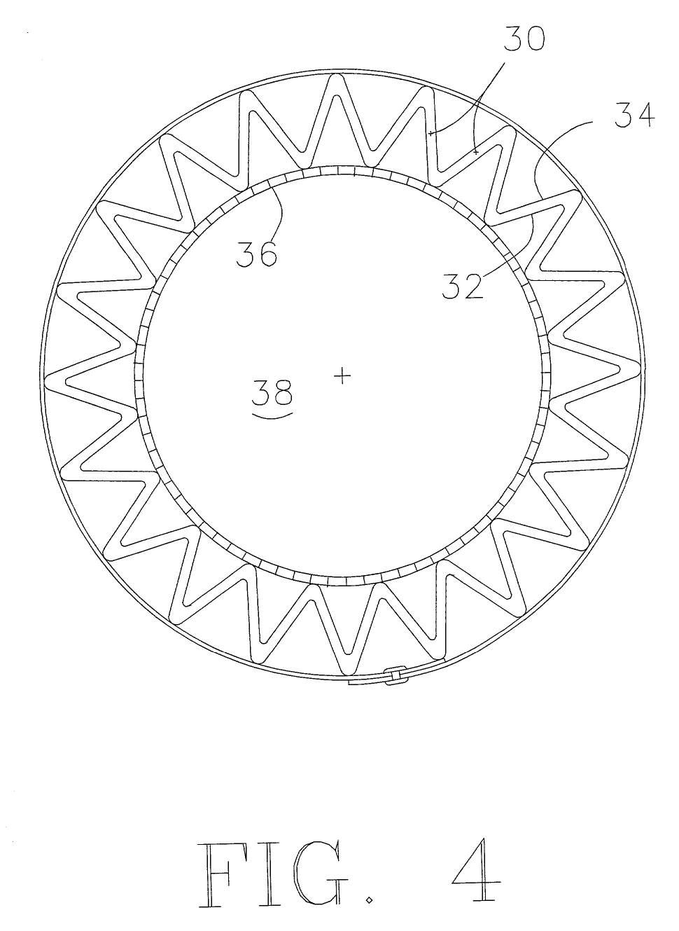

The filter cartridge 26 is illustrated in FIGS. 2-4, and includes a fabric filter or medium 28 made according to the present invention. The filter cartridge 26 is generally tubular and includes a number of pleats 30. The pleats have in inner surface 32 and an outer surface 34.

In a preferred embodiment, pleats 30 (best seen in FIG. 4) abut an inner screen 36 defining a central passageway 38 formed within the filter cartridge 26. The fabric filter 28 and screen 36 are aligned and held in place by an upper cap 40 and a lower cap 42. Upper cap 40 includes a projecting shoulder 44 that holds the cartridge in place against tubesheet 18 and prevents the cartridges from falling through openings 24. The assembly 26 is further strengthened by a fabric strap 46, described in more detail in U.S. Pat. No. 6,233,790 B1 to C. G. Carothers, incorporated herein by reference.

In operation, the dirty air enters dirty air plenum 14 through inlet 20 and is filtered through the filter cartridges 26. As the air moves through the filter medium 28 into the central passageway 38 particles are trapped against outer surface 34. The cleaned air then exits passageway 38 into the clean air plenum 16 and is removed from baghouse 10 through outlet 22. The movement of air into and out of the baghouse is shown by the arrows extending through the inlet 20 and outlet 22 in FIG. 1. As the filtered particles build up against the outer surface 34 of filter medium 28, the efficiency of baghouse 10 decreases. In order to remove the particles, air is pulsed in the reverse direction of airflow during the filtering operation. Air is pulsed at a desired rate to maintain the desired airflow during filtering operation. The reverse pulse “blows” the particles off the outer surface 34 of filter medium 28. The particles fall to the bottom of dirty air plenum 14 and can be removed in any manner known in the art.

While the illustrated baghouse, cartridge and strap are preferred, it is understood that any suitable baghouse, cartridge and/or strap design may be utilized with the present invention. Further, the filter medium 28 of the present invention may be utilized with other cartridge 26 configurations and in other filtering operations.

The improved filter medium 28 of the present invention includes at least two fibers. The first fiber is selected for chemical resistance and stability in the environment of the intended operation. The second fiber is selected to have a higher Tg (glass transition temperature) relative to the first fiber. It has been determined that the proper selection and the proper percentage of the second fiber facilitates raising the Tg of the final substrate without diminishing the chemical resistance properties of the first fiber.

In general, the percentage of the first fiber is in an amount effective to render the filter medium 28 chemically stable during filtering. The percentage of the second fiber is in an amount effective to render the filter medium stiff enough to retain the shape or “structure” of the filter medium, by preventing the pleats from “collapsing”, at the operation temperature.

The following mixtures of fibers in the filter medium are given as examples and are not meant to be limiting.

Fibers made from polyarylene sulfides, including PPS, are desirable for use in the filter medium 28 when used in certain baghouse filtering operations because of the high level of resistance to chemical environments. This is especially desirable in operations such as coal fired boilers. Unfortunately, the Tg of PPS, 185-188° F. (8586.7° C.), results in softening problems and non-curing of the stiffening resins, as discussed above. It has been determined, however, that upon blending another fiber with a significantly higher Tg, the Tg of the filter medium 28 is raised sufficiently that the filter medium does not soften, allowing the stiffening resin to fully harden. The stiffening resin may be any conventional stiffening agent or an improved polyimide based stiffening agent that is the subject of co-pending application Ser. No. ______, common assignee of the present invention, incorporated herein by reference. The filter medium 28 retains the resistance to chemical environments typical of PPS.

Fibers with relatively high Tg polymers suitable for blending with the first PPS fibers include polyimide (P84), glass, pre-oxidized acrylic, aromatic polyimide (aramid), and mixtures thereof. The preferred mixture of fibers in the filter medium 28 include about 65% to about 90% PPS, with 75% to 85% PPS more preferred, mix with preferably 10% to 35% of the higher Tg second fiber, 15% to 25% more preferred. (All percentages given are weight/weight percentages based on the total weight of the mixture unless otherwise noted.)

Homopolymer acrylic polymers are preferred first fibers in operations where hydrolysis of the substrate polymer is a concern, such as cement and kaolin processes. The relatively low Tg of acrylic homopolymers, 185-188° F. (85-86.7° C.) is effectively overcome by mixing the homopolymer acrylic with a second fiber pre-oxidized acrylic (PAN). The preferred mixture includes about 65% to about 90% homopolymer acrylic, with 75% to 85% homopolymer acrylic more preferred, blended with preferably 10% to 35% of the higher Tg polymer, PAN, 15% to 25% more preferred.

### EXAMPLE 1

Six samples of non-woven blended PPS were produced by known methods by Southern Felt Co. of North Augusta, S.C. in the following percentages:

75% PPS-25% aromatic polyimide (aramid)

50% PPS-50% aromatic polyimide (aramid)

25% PPS-25% aromatic polyimide (aramid)

75% PPS-25% polyimide (P84)

50% PPS-50% polyimide (P84)

25% PPS-75% polyimide (P84)

Each of the samples were treated as follows:

The fibers were processed into a needlefelt. The needlefelt was immersed into a stiffening resin and the excess removed by nip rollers to produce about a 15% pickup. The treated media was placed in an oven at 400° F. (204.4° C.) for about two weeks. Upon removal all samples were sufficiently stiff to suggest that the resultant Tg of the blended polymer was raised sufficiently to allow the stiffening agent to fully cure and stiffen, effectively overcoming the low Tg of PPS.

### EXAMPLE 2

Samples of a non-woven mixture of 75% PPS-25% polyimide (P84), and control samples of 100% PPS were produced by known methods by Southern Felt Co. of North Augusta, S.C. The fibers were processed and treated as in Example 1, and the filtration medium 28 was pleated by a conventional method.

A sample of each of the treated filter media were placed in a 375° F. (191° C.) oven and a 1.25 psi load was applied. The pleats of the 100% PPS medium were crushed. The mixed filter media 28 of the present invention exhibited pleat retention.

A sample of each of the treated media were subjected to repeated baghouse pulsing at 350° F. (176.7° C.). The 100% PPS medium exhibited bowing or closing of the pleats at 50,000 pulses, thereby reducing effective surface area of the filter. The mixed filter media 28 of the present invention exhibited pleat retention at 100,000 pulses.

The presently preferred embodiments have been described, however, many variations are possible. As noted above, the filter medium 28 of the present invention may be advantageously used with the illustrated baghouse, however, the present invention may be used with any suitable baghouse or filtering apparatus. Moreover, although the filter medium of the present invention is particularly advantageous when used with a pleated filter medium, the invention is equally applicable to filter media of varying structures and operations.

While the filter medium of the present invention overcomes the limitations of high temperature filtering operations, the present invention may also be used in lower temperature operations.

Having described the invention in detail, those skilled in the art will appreciate that modifications may be made of the invention without departing from its spirit and scope. Therefore, it is not intended that the scope of the invention be limited to the specific embodiments described. Rather, it is intended that the scope of the invention be determined by the appended claims and their equivalents.

1. A filter medium having a filter structure and adapted for use in a filter cartridge operating at a filtering temperature, said filter medium comprising:
at least one first fiber made from a first polymer having a first glass transition temperature and being selected to be chemically stable during the filtering operation, said first fiber present in an amount effective to render the filter medium chemically and thermally stable during a filtering operation; and
at least one second fiber made from a second polymer having a second glass transition temperature higher than the first glass transition temperature, said second fiber present in an amount effective to render the filter medium stiff enough to retain the filter structure at the filtering temperature.

2. The filter medium of claim 1 wherein the at least one first fiber includes a polyphenylene sulfide and the at least one second fiber includes a polymer selected from the group comprising an aramid, polyimide, and mixtures thereof.

3. The filter medium of claim 1 wherein the at least one first fiber includes a homologized acrylic and the at least one second fiber includes a polymer selected from the group comprising an aramid, glass, polyimide, pre-oxidized acrylic, and mixtures thereof.

4. The filter medium of claim 1 further including a polymer stiffening agent applied to the filter medium.

5. A filter medium having a filter structure and adapted for use in a filter cartridge at a filtering temperature, said filter medium comprising:
about 65 wt/wt % to about 90 wt/wt % at least one first fiber made from at least one first polymer having a first glass transition temperature and being selected to be chemically and thermally stable during a filtering operation; and
about 10 wt/wt % to about 35 wt/wt % at least one second fiber made from at least one second polymer having a second glass transition temperature higher than the first glass transition temperature, the second glass transition temperature being high enough to render the filter medium stiff enough to retain the filter structure at the filtering temperature.

6. The filter medium of claim 5 wherein the at least one first fiber includes a polyphenylene sulfide and the at least one second fiber includes a polymer selected from the group comprising an aramid, polyimide, and mixtures thereof.

7. The filter medium of claim 5 wherein the at least one first fiber includes an homologized acrylic and the at least one second fiber includes a polymer selected from the group comprising an aramid, glass, polyimide, pre-oxidized acrylic and mixtures thereof.

8. The filter medium of claim 5 further including a polymer stiffening agent applied to the filter medium.

9. The filter medium of claim 5 wherein the filter structure is a pleated structure.

10. A filter medium having a pleated structure and adapted for use in a filter cartridge at a filtering temperature, said filter medium comprising:
about 75 wt/wt % to about 85 wt/wt % at least one first fiber made from at least one first polymer having a first glass transition temperature and being selected to be chemically and thermally stable during a filtering operation; and
about 15 wt/wt % to about 25 wt/wt % at least one second fiber made from at least one second polymer having a second glass transition temperature higher than the first glass transition temperature, the second glass transition temperature being high enough to render the filter medium stiff enough to retain the filter structure at the filtering temperature.

11. The filter medium of claim 10 wherein the at least one first fiber includes a polyphenylene sulfide and the at least one second fiber includes a polymer selected from the group consisting of an aramid, polyimide, and mixtures thereof.

12. The filter medium of claim 10 wherein the at least one first fiber includes an homologized acrylic and the at least one second fiber includes a polymer selected from the group comprising an aramid, glass, polyimide, pre-oxidized acrylic and mixtures thereof.

13. The filter medium of claim 10 further including a polymer stiffening agent applied to the filter medium.

14. A method of making a filter medium comprising the steps of:
providing a filter medium comprising:
at least one first fiber made from at least one first polymer having a first glass transition temperature and being selected to be chemically stable during a filtering operation, the first fiber present in an amount effective to render the filter medium chemically and thermally stable during a filtering operation; and
at least one second fiber made from at least one second polymer having a second glass transition temperature higher than the first glass transition temperature, the second fiber present in an amount effective to render the filter medium stiff enough to retain the filter structure at the filtering temperature;
calendering the filter medium;
providing a stiffening agent;
treating the filter medium with the stiffening agent; and
curing the treated filter medium.

15. The method of claim 14 wherein the stiffening agent is selected from the group consisting of polyimides, epoxies, acrylics, melamines, and phenol formaldehydes.

16. The method of claim 14 further including pleating the treated filter medium.

17. The method of claim 14 wherein the substrate is treated with the stiffening agent prior to calendering the filter medium.

18. A method of making a filter medium comprising the steps of:
providing a filter medium comprising;
at least one first fiber made from at least one first polymer having a first glass transition temperature and being selected to be chemically stable during a filtering operation, the first fiber present in an amount effective to render the filter medium chemically and thermally stable during the filtering operation; and
at least one second fiber having a second glass transition temperature higher than the first glass transition temperature, the second fiber present in an amount effective to render the filter medium stiff enough to retain the filter structure at the filtering temperature;
calendering the filter medium;
providing at least one stiffening agent;
treating the filter medium with the at least one stiffening agent;
curing the treated filter medium; and
pleating the treated medium.

19. The method of claim 18 wherein the at least one stiffening agent includes a stiffening agent selected from the group consisting of polyimides, epoxies, acrylics, melamines, and phenol formaldehydes.

20. The method of claim 18 wherein the substrate is treated with the stiffening agent prior to calendering the filter medium.

21. The method of claim 18 wherein the at least one first fiber includes polyphenylene sulfide and the at least one second fiber includes a polymer selected from the group consisting of aramid, polyimide, and mixtures thereof.

22. The method of claim 18 wherein the at least one first fiber includes an homologized acrylic and the at least one second fiber includes polymer selected from the group comprising an aramid, glass, polyimide, pre-oxidized acrylic and mixtures thereof.
